(19) United States
(12) Patent Application Publication
(10) Pub. No.: US 2020/0400820 A1
(43) Pub. Date: Dec. 24, 2020

(54) Distance Detection System, Method for a Distance Detection System and Vehicle

(71) Applicant: OSRAM Beteiligungsverwaltung GmbH, Grünwald (DE)

(72) Inventor: Andre NAUEN, Regensburg (DE)

(73) Assignee: OSRAM Beteiligungsverwaltung GmbH, Grünwald (DE)

(21) Appl. No.: 16/962,576

(22) PCT Filed: Dec. 6, 2018
(86) PCT No.: PCT/EP2018/083716

§ 371 Date: Jul. 16, 2020

(30) Foreign Application Priority Data
Jan. 26, 2018 (DE) 10 2018 201 220.2

(51) Int. Cl. G01S 17/10; G01S 7/4865

(52) U.S. Cl. CPC G01S 17/10; G01S 17/931; G01S 7/4865

(57) ABSTRACT

Systems and methods disclosed herein include a distance detection system comprising an emitter unit configured to emit electromagnetic measurement pulses for distance measurements; and a receiver unit configured to capture the electromagnetic measurement pulses, characterized in that at least one of a shape, a temporal distance, and a number of the emitted measurement pulses are varied.

The invention is based on a distance detection system in accordance with the preamble of claim 1. Furthermore, the invention relates to a method for a distance detection system. Moreover, a vehicle comprising a distance detection system is provided.

For distance and speed measurement, the light detection and ranging (lidar) system is known from the prior art. Lidar systems make it possible to rapidly capture the surroundings and the speed and direction of movement of individual objects. Lidar systems are used for example in partly autonomously driving vehicles or autonomously driving prototypes, and also in aircraft and drones. The lidar system employs high-resolution sensor systems for aligning an emitted laser beam and also lenses, mirrors or micromirror systems.

The lidar distance measurement is based on a time of flight measurement of emitted electromagnetic pulses. If the latter impinge on an object, then at the surface thereof the pulse is reflected proportionally back to the distance measuring unit and can be recorded as an echo pulse by a suitable sensor. If the pulse is emitted at a point in time t₀ and if the echo pulse is captured at a later point in time t₁, the distance d to the reflective surface of the object can be ascertained by means of the time of flight Δt_A=t₁−t₀ according to

d=(Δt_A*c)/2

Since electromagnetic pulses are involved, c is the value of the speed of light. The lidar method expediently operates with light pulses which, using semiconductor laser diodes having a wavelength of 905 nm, for example, have an FWHM pulse width tp of 1 ns<tp<100 ns (FWHM=Full Width at Half Maximum).

In order to improve signal-to-noise ratios, in a lidar system a plurality of the measurements or individual pulse measurements explained above can be computed with one another in order for example to improve the signal-to-noise ratio by way of an averaging of the measurement values determined.

Furthermore, the prior art discloses transmitter and receiver concepts of various designs for the lidar system, wherein for example distance information can be captured in different spatial directions. In this case, by way of example, a two-dimensional image of the surroundings can be generated, said image containing complete three-dimensional coordinates for each spatial point resolved.

Lidar systems usually emit light signals in the infrared wavelength range of between 850 nm and 1600 nm.

If a lidar system is used in a vehicle, then it is problematic if two vehicles A and B, each equipped with a lidar, move toward one another. In such a case, the lidar system of vehicle A (lidar A) will capture its emitted light signals that are reflected at vehicle B. Furthermore, it is possible that the light signals emitted by the lidar system of vehicle B (lidar B) will be received by lidar A. A first basic prerequisite for this is that lidar A and lidar B are used in the same wavelength range. By way of example, at the present time a large proportion of currently known lidar systems are based on laser diodes that emit radiation having a wavelength of 905 nm. A further, second basic prerequisite is that the light signals emitted by lidar B arrive within a capture time Δt_M of lidar A, within which the latter records light signals. A further, third basic prerequisite may be considered to be that both lidar systems emit their light signals or measurement pulses sufficiently regularly and with an identical frequency or pulse frequency. The third basic prerequisite is probable at least for structurally identical lidar systems. However, different lidar systems that use for example identical laser diodes with their respective requirements in respect of frequency or “duty cycle” may also satisfy said third basic prerequisite. As a fourth basic prerequisite it is necessary for the light signals of lidar B that are captured by lidar A or the pulse power of lidar B that arrives at lidar A to lie above a detection threshold of lidar A. This is the case for example if both vehicles A and B are on a collision course, since there is a direct optical path between them in this case. However, said fourth basic prerequisite may also be satisfied in the case where the light signals emitted by lidar B are reflected by the surroundings. If all the basic prerequisites or at least the basic prerequisites one, two and four are satisfied, then the light signals emitted by lidar B generate an illusory object from the point of view of lidar A. Two cases can be differentiated here. If the light signal emitted by lidar B arrives within the capture time Δt_M, but later than the light signal emitted by lidar A and subsequently reflected, then the illusory object is recognized at a greater distance from lidar A than vehicle B. This is comparatively noncritical for hazard recognition and handling by vehicle A since only the closest object is usually relevant to vehicle A. However, if lidar A has a multi-target capability at least within a solid angle segment, this can result in undesired effects. In the opposite case, that is to say if the light signal emitted by lidar B is captured earlier at lidar A, an illusory object may be captured by lidar A at a small distance in comparison with the object actually recognized, namely vehicle B. If vehicle A is an autonomously or partly autonomously driving vehicle, then this may result in unnecessarily severe braking, which may in turn be dangerous for other road users.

The object of the present invention is to provide a distance detection system that is usable in a reliable manner. Moreover, it is an object of the invention to provide a method with a distance detection system which results in a reliable detection. Furthermore, it is an object of the invention to provide a vehicle that is usable in a reliable manner.

The object with regard to the distance detection system is achieved in accordance with the features of claim 1 or 14, the object with regard to the method is achieved in accordance with the features of claim 8, and the object with regard to the vehicle is achieved in accordance with the features of claim 13.

Particularly advantageous configurations are found in the dependent claims.

The invention provides a distance detection system, in particular a light detection and ranging (lidar) system. This system can comprise an emitter unit or radiation source, by means of which electromagnetic measurement pulses or light signals for distance measurement are able to be emitted. Furthermore, the distance detection system can comprise a receiver unit or a sensor, by means of which the electromagnetic measurement pulses are able to be captured. Advantageously, a shape and/or a sequence and/or a distance and/or a number of the emitted measurement pulses are/is varied.

This solution has the advantage that variation of the measurement pulses reduces or suppresses interference by light signals or measurement pulses of other lidar systems. In particular, on account of the variation of the measurement pulses, the receiver unit can assign them to the emitter unit in a less ambiguous manner or in an unambiguous manner. A detection of illusory objects is thus at least reduced or even prevented.

Preferably, the variation provided can be a variation of a gradient and/or of a shape and/or of a width of a falling and/or rising edge of an emitted measurement pulse. A falling edge is preferably that edge which is temporally downstream of the rising edge and is thus emitted and received after the rising edge. It has been found that the variation of the falling edge is extremely advantageous since the latter is easily able to be captured and evaluated by the receiver unit.

In a further configuration of the invention, a shape and/or a sequence and/or a distance of the emitted measurement pulses can be varied stochastically. A susceptibility of the distance detection system to interference vis à vis illusory objects is reduced further as a result. Moreover, the situation in which distance detection systems carry out an identical variation of the measurement pulses is avoided. The stochastic variation can be based on random numbers, which can be obtained by standard methods from computer technology, for example. The standard methods are based on Fibonacci series, for example. It is also conceivable for physical sources, such as the thermal noise of a resistor, to be used as a source of the random numbers.

The variation or the stochastic variation of the measurement pulse is preferably carried out by means of a control unit connected to the emitter unit.

Furthermore, it is conceivable to vary the entire width of the measurement pulse or to vary a width of the measurement pulse between two edges. Alternatively, a width of a measurement pulse can also remain the same, for example in the course of the variation of the shape of said pulse. In a further configuration of the invention, it is conceivable to vary an overall pulse shape of a measurement pulse as the variation. Said pulse can then have for example a Gaussian shape or a Lorentzian shape or a sawtooth shape. The variation is preferably effected for one measurement pulse or for a portion of the measurement pulses or for all of the measurement pulses.

A temporal width of a falling edge is for example at least 10 ns, in particular at least 50 ns, in particular at least 100 ns. Preferably, the variation or stochastic variation of a measurement pulse is effected within predefined limits. By way of example, the width of the falling edge can be between 1 ns and 100 ns.

In a further configuration of the invention, provision can be made of a recording device for recording the pulse shape of the respective measurement pulse emitted by means of the emitter unit. It is thereby possible thus to record a reference measurement pulse for a respective measurement pulse. The recorded pulse shape can then advantageously be used for example for coordinating comparison with a received measurement pulse in order to ascertain whether the received measurement pulse is an emitted measurement pulse.

In a further configuration, a or the control unit can be provided and configured in such a way that the reference measurement pulse recorded by the recording device or the recorded reference measurement pulses can be compared with a measurement pulse received by the receiver unit by way of said control unit. In particular, in this case, by means of the control unit, it is possible to compare a pulse shape between the reference pulse and the received measurement pulse in order advantageously to check whether the received measurement pulse was emitted by the emitter unit and is not an interference pulse.

Advantageously, a or the control unit can be configured in such a way that the comparison of the reference measurement pulse with the captured measurement pulse is effected in a simple manner by means of a comparison method configured in particular so as to compare two pulse shapes. One comparison method is a signal analysis function, for example. By way of example, a sufficiently known cross-correlation function can be provided as the signal analysis function. It is also conceivable to compare a reference measurement pulse with a received measurement pulse by means of a plurality of different signal analysis functions or comparison methods in order to further increase data integrity. By means of the signal analysis function, it is possible to determine, in particular, whether a measurement pulse received by means of the receiver unit is a measurement pulse emitted by the emitter unit.

Besides an emitter unit or radiation source and a receiver unit, the distance detection system can comprise one or a plurality of adjustable mirrors that can direct the radiation emitted by the radiation source into different solid angle segments. By way of example, a MEMS (Micro-Electro-Mechanical System) system having oscillating mirrors can be provided. The oscillating mirrors or micromirrors of the MEMS system, preferably in interaction with an optical unit disposed downstream, allow a field of view to be scanned in a horizontal angular range of e.g. 60° or 120° and in a vertical angular range of e.g. 30°. The receiver unit or the sensor can measure the incident radiation without spatial resolution. However, the receiver unit can also exhibit solid angle resolution. The receiver unit or the sensor can be a photodiode, e.g. an avalanche photodiode (APD) or a single photon avalanche diode (SPAD), a PIN diode or a photomultiplier. The lidar system can capture objects at a distance of up to 60 m, up to 300 m or up to 600 m, for example. A range of 300 m corresponds to a signal path distance of 600 m, which can result in a measurement time window or a measurement duration of 2 μs, for example.

The invention provides a method with a distance detection system in accordance with one or more of the preceding aspects. Preferably, a shape and/or a sequence and/or a distance and/or a number of the emitted electromagnetic measurement pulses are/is varied. This affords the advantages mentioned above, namely that illusory objects can be differentiated from actual objects. By virtue of the method, illusory objects can thus be recognized and filtered out by the distance detection system.

Preferably, the variation of the measurement pulses is effected stochastically in order to improve the method further. The variation or stochastic variation of the measurement pulses is preferably effected as already explained above.

Preferably, the emitted measurement pulses are compared with the received measurement pulses by means of a comparison method, in particular by means of a signal analysis function, in particular as already explained above. This is effected for example by reference measurement pulses being recorded.

The method is preferably effected with the following step:
carrying out a measurement series with at least one individual measurement or a plurality of individual measurements, wherein an individual measurement begins with the emission of a measurement pulse and extends over a capture time Δt_M of the receiver unit.

In order to determine a time of flight value Δt_A,i of a measurement pulse received by the receiver unit, the following step can be provided:
determining or extracting the time of flight value Δt_A,i of a measurement pulse or of a respective measurement pulse. The determining is preferably effected when the measurement pulse or the respective measurement pulse of an individual measurement is captured by the receiver unit. A time of flight value can be considered to be a difference between a point in time at which the measurement pulse is emitted and the point in time at which the measurement pulse is captured.

Preferably, an averaging of the captured measurement pulses and/or an averaging of the time of flight values Δt_A,i determined are/is effected. A measurement reliability can be increased as a result.

Preferably, a temporal distance or time of flight Δt_i of the points in time of the emissions or starting points in time of the individual measurements is varied or varied stochastically. As a result, the sequence of the measurement pulses can be varied stochastically. Preferably, at the starting point in time or approximately at the starting point in time, the reception readiness of the receiver unit for possibly capturing the individual measurement also begins, as a result of which the capture time Δt_M can be started. If a plurality of measurement series are provided, then it is conceivable for a temporal distance or time of flight Δt_iM of the points in time of the start of the measurement series to be varied or to be varied stochastically.

In a further configuration of the invention, a number of individual measurements for a respective measurement series, as already mentioned above, can be varied or be varied stochastically in order to improve the method and to identify illusory objects in a simple manner.

The radiation emitted by the emitter unit can be for example infrared (IR) radiation in a wavelength range of approximately 1050 nm or 905 nm that is emitted by a laser diode. However, other wavelengths, e.g. 808 nm or 1600 nm, that are suitable for capturing the surroundings are also possible. A combination of a plurality of wavelengths is also conceivable in order to be able for example to recognize obstacles composed of different materials or under different weather conditions.

A pulse duration or pulse width Δt_p is preferably between 0.1 ns and 100 ns, preferably between 1 ns and 20 ns. A capture time Δt_M of an individual measurement is 2 μs, for example. A number n of individual measurements can be greater than or equal to 1. By way of example, a number n of individual measurements, in particular of a measurement series, is 100 or between 1 and 100. Preferably, the number n of individual measurements of a measurement series can vary or vary stochastically. A pulse rate can be for example 100 kHz or preferably between 1 kHz and 1 MHz or preferably between 1 kHz and 100 kHz. A minimum value of the distance or of the time of flight Δt_iM and/or of the distance or of the time of flight Δt_i is, in particular approximately, 20 ns. A maximum value of the time of flight Δt_iM and/or of the time of flight Δt_i is preferably, in particular approximately, 300 ns.

In a further configuration of the invention, carrying out the measurement series can be effected during a predefined total measurement duration Δt_int of the receiver unit. Preferably, the total measurement duration Δt_int for the plurality of individual measurements or for the measurement series is at most short enough that a quasi-static situation is present. It can thus advantageously be assumed that the total measurement duration Δt_int is short enough that a static situation can be assumed even in the case of a movement of the distance detection system relative to the surroundings and of objects therein. By way of example, the total measurement duration Δt_int is varied or is varied stochastically. The total measurement duration Δt_int is thus preferably adapted to the purpose of use of the distance detection system. If the distance measuring system is used for example in a vehicle moving at 100 km/h and the vehicle is approached by a vehicle having a separate distance detection system at 100 km/h, then a relative movement of 56 mm/ms results. If the total measurement duration Δt_int is 1 ms, then a quasi-static case can be assumed since the distance between the two vehicles does not change in a relevant way within Δt_int in regard to a typical distance measurement accuracy.

In a further configuration of the invention, a time of flight Δt_A or the time of flight values Δt_A,i of a captured measurement pulse or of captured measurement pulses can be determined by means of a histogram method, in addition or as an alternative to the comparison method. The time of flight or the time of flight values can be determined in a simple and reliable manner by means of the histogram method. If it is used in addition to the comparison method, for example before, in parallel with or after the comparison method, then a measurement reliability and any susceptibility vis à vis interference pulses can be reduced further.

Preferably, the following steps can be provided in the histogram method:
entering the measurement pulses determined, in particular the time of flight values Δt_A,i determined, into a histogram. It is thus possible to generate a time histogram made from all Δt_A,i.
furthermore, determining a time of flight Δt_A from the histogram can be effected. The time of flight Δt_A is preferably a maximum value in the histogram. By virtue of the variation or stochastic variation of the shape and/or sequence and/or distance and/or number of the electromagnetic measurement pulses, the correct measurement pulse or the correct time of flight Δt_A can then be filtered out reliably from the histogram.

An entry into the histogram is preferably effected after each determination of the time of flight value Δt_A,i or after the determination of a plurality of time of flight values Δt_A,i of one or a plurality of measurement pulses.

By means of the comparison method as mentioned above, for example, a time of flight Δt_A or time of flight values Δt_A,i can likewise be determined. If it is not possible to determine a time of flight Δt_A from the histogram and/or by means of the comparison method and/or if the measurement quality is intended to be increased, then preferably at least one further measurement series is started. In the latter, the histogram method and/or the comparison method can then be applied again. It is conceivable to start new measurement series until a time of flight Δt_A or time of flight values Δt_A,i can be determined.

Preferably, the time of flight Δt_A or the time of flight value Δt_A,i can be captured if the latter exceeds a predetermined threshold value in the histogram.

Advantageously, the time of flight values Δt_A,i in the histogram can have a temporal distribution width δ_A. In this case, a temporal distance δ_t or a temporal variation amplitude δ_t between the measurement pulses is preferably greater than the distribution width δ_A. A ratio of δ_t to δ_A is preferably between 5 and 100, that is to say 5≤δ_t/δ_A≤100.

Preferably, the histogram method and/or the comparison method are/is carried out after a measurement series with a plurality of individual measurements or after a respective individual measurement.

As already mentioned above, it is conceivable for the pulse shape of a measurement pulse or of a respective measurement pulse or of a portion of the measurement pulses to be recorded as or in each case as a reference measurement pulse by the recording device, particularly in the case of a variation or stochastic variation of the measurement pulse or measurement pulses. Consequently, in the case of a respective individual measurement, the recorded pulse shape of the reference measurement pulse can be compared with the pulse shape of the captured measurement pulse, in particular in order to differentiate the intrinsic signal from interference or extraneous signals.

The comparison method is preferably carried out after each individual measurement or after each measurement series, wherein the time of flight value Δt_A can be determined for example from a maximum of a cross-correlation function. Preferably, after each individual measurement or after each measurement series, the temporal position of the maxima or of the maximum, particularly in the case of the cross-correlation function, or the temporal positions of the n highest maxima, particularly in the case of the cross-correlation function, that exceed a predefined threshold value is/are determined.

In a further configuration of the invention, a shape section or a shape parameter or a characteristic shape parameter of a respective reference measurement pulse and a shape section or a shape parameter or a characteristic shape parameter of a captured measurement pulse can be compared. In the case of correspondence of the compared shape sections, the captured measurement pulse can be used for determining the time of flight Δt_A and/or for the histogram method and/or for the comparison method.

The shape section is preferably extracted. In order to extract the shape section, a temporal pulse position of the captured measurement pulse can be determined, wherein the position of the maximum value can be taken as a basis, for example. By way of example, a full width at half maximum of the falling edge of the measurement pulse and of the reference measurement pulse can be provided as the shape section.

The following steps can be provided for the method for comparing the shape sections:
Determining a temporal pulse position of at least one captured measurement pulse or of a plurality of captured measurement pulses, in particular of an individual measurement or of a measurement series.
Alternatively or additionally, provision can be made for determining or ascertaining the shape section of the at least one captured measurement pulse or of a plurality of the captured measurement pulses or of all the captured measurement pulses.
Comparing the shape section or all the shape sections with the shape section of the reference measurement pulse.
Determining the time of flight value Δt_A,i of the measurement pulse or of a plurality of measurement pulses for which, upon comparison, there is correspondence and/or at most a maximum deviation.

Furthermore, the following steps can be provided:
Repeating the individual measurement or the measurement series.
Carrying out the histogram method with the at least one measurement pulse or a plurality of measurement pulses for which there is envisaged correspondence with regard to the shape sections in order to capture a time of flight Δt_A.

The invention provides a distance detection system that is used in accordance with the method according to one or more of the preceding aspects.

The invention can provide a vehicle comprising a distance detection system in accordance with one or more of the preceding aspects.

The vehicle can be an aircraft or a waterbound vehicle or a landbound vehicle. The landbound vehicle can be a motor vehicle or a rail vehicle or a bicycle. Particularly preferably, the vehicle is a truck or a car or a motorcycle. The vehicle can furthermore be configured as a non-autonomous or partly autonomous or autonomous vehicle.

The invention will be explained in greater detail below on the basis of exemplary embodiments. In the figures:

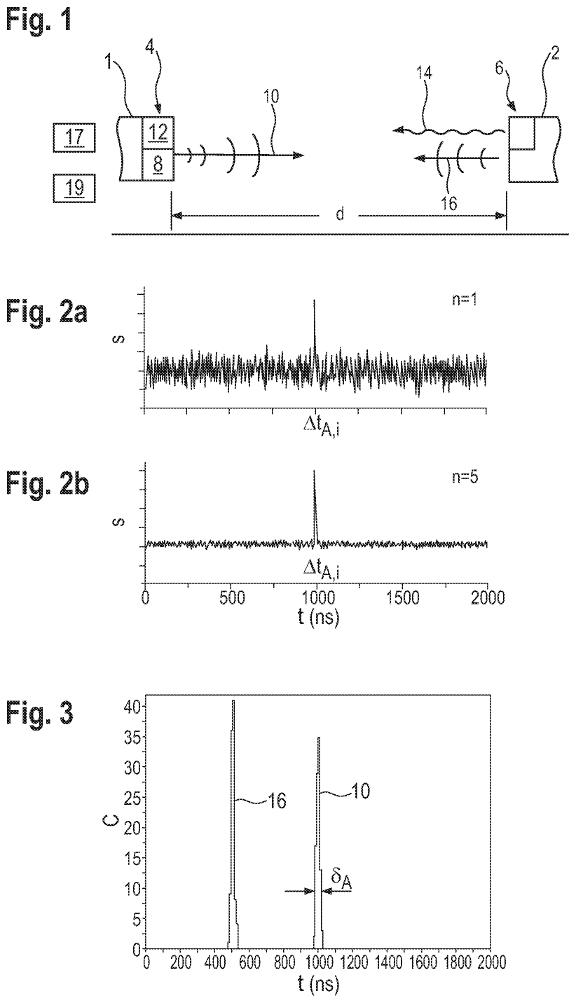

FIG. 1 shows two vehicles with a distance detection system in a schematic illustration,

FIG. 2a shows an individual measurement of a distance detection system in a diagram,

FIG. 2b shows a plurality of individual measurements in a diagram,

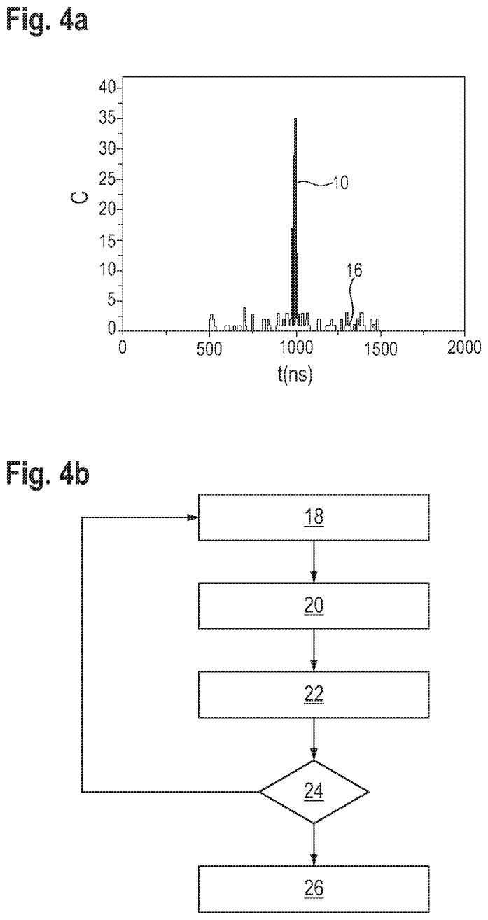

FIGS. 3 and 4a show a signal evaluation of the distance detection system in each case in a histogram,

FIG. 4b shows a histogram method in a flow diagram,

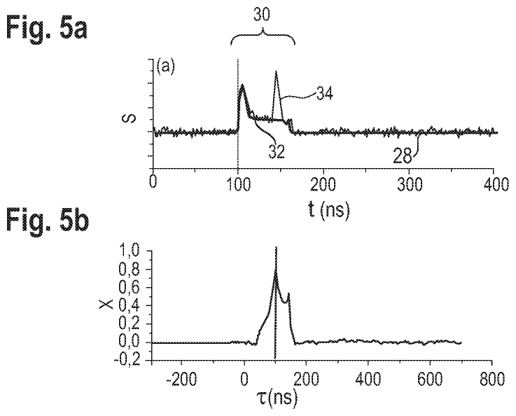

FIGS. 5a, 6a, 7a, 8a show an individual measurement together with a recorded reference signal of the distance detection system in each case in a diagram,

FIGS. 5b, 6b, 7b, 8b show an illustration of a cross-correlation function for comparing a measurement pulse with a reference measurement pulse in each case in a diagram,

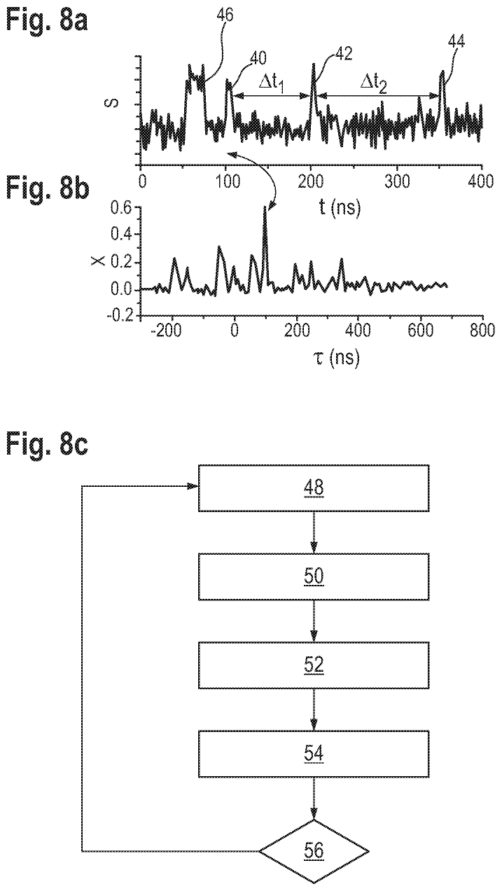

FIG. 8c shows a further method in a flow diagram,

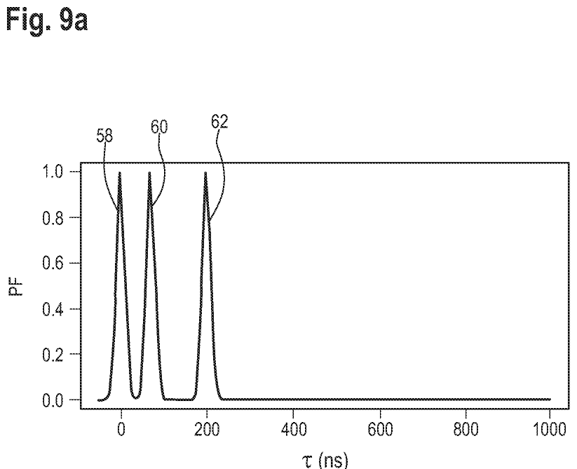

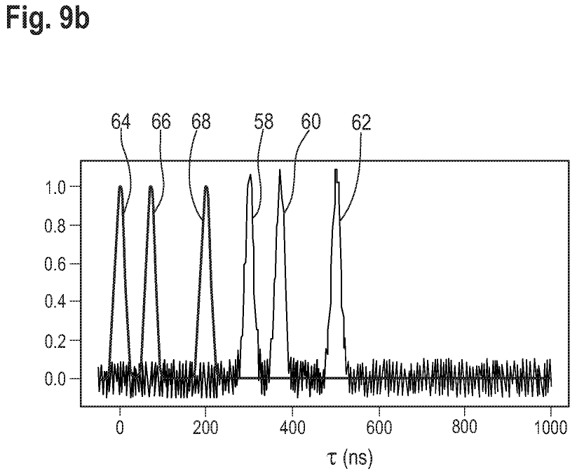

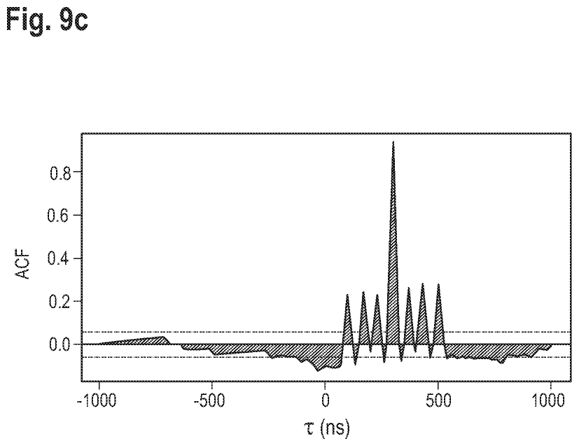

FIGS. 9a, 10a and 11a show measurement pulses emitted by means of a distance detection system in a diagram,

FIG. 9b shows measurement pulses received by means of a distance detection system in a diagram,

FIGS. 9c, 10b and 11b show an illustration of a cross-correlation function for comparing received measurement pulses with reference measurement pulses in a diagram, and

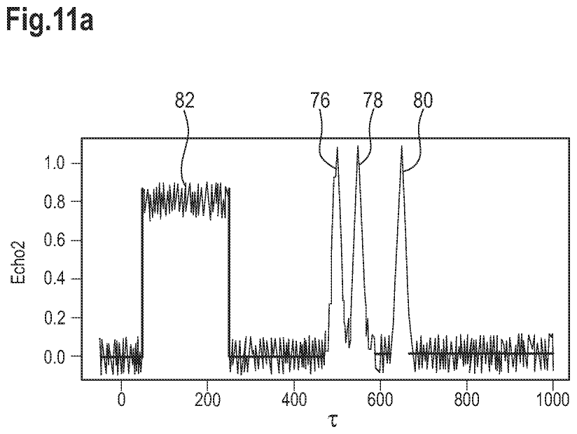

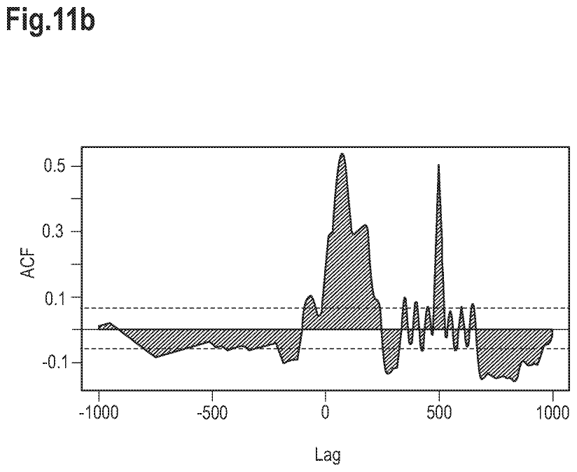

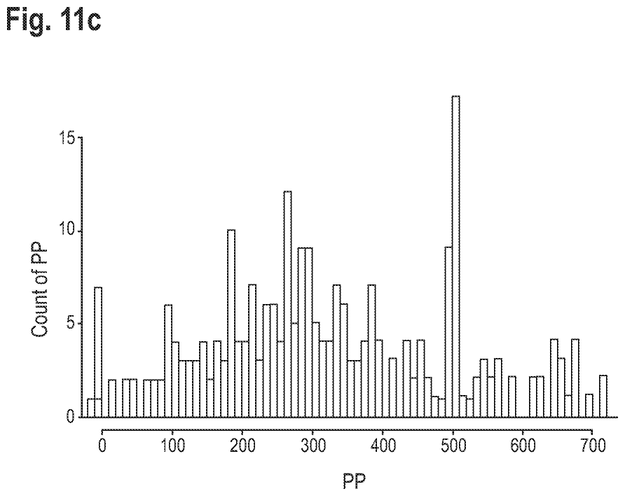

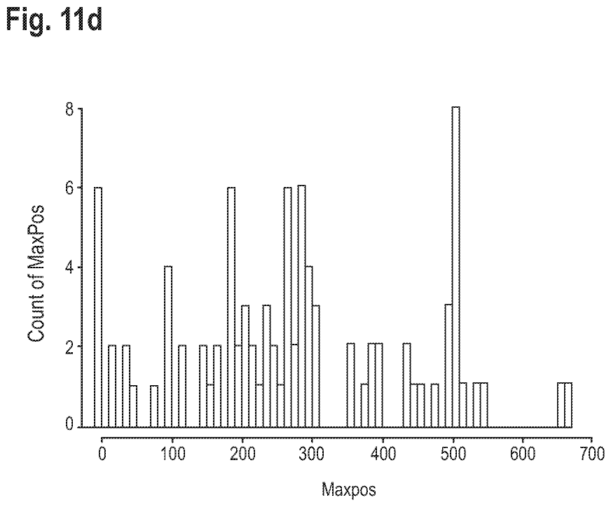

FIGS. 11c and 11d show a signal evaluation of the distance detection system in each case in a histogram.

FIG. 1 schematically shows vehicles 1 and 2. The latter respectively have a distance detection system 4 and 6. In this case, the distance detection system 4 of the vehicle 1 comprises an emitter unit 8, by means of which electromagnetic measurement pulses 10 are able to be emitted. By means of a receiver unit 12, electromagnetic radiation can then be received by the distance detection system 4, such as, for example, a measurement pulse 14 emitted by the distance detection system 4 of the vehicle 1 and reflected at the vehicle 2. Furthermore, the receiver unit 12 can also receive interference pulses, such as, for example, measurement pulses 16 emitted by the vehicle 2. In FIG. 1, provision is additionally made of a recording device 17 for recording a reference measurement pulse of the respective measurement pulse 10 emitted by means of the emitter unit 8. Furthermore, a control unit 19 is shown schematically, said control unit being configured in such a way that the reference measurement pulse recorded by the recording device 17 is compared with a measurement pulse 14 received by the receiver unit by means of said control unit.

FIG. 2a shows an individual measurement of the distance detection system 4 from FIG. 1, wherein the ordinate represents the signal strength s and the abscissa represents time t in ns. In this case, a capture time Δt_M of the individual measurement is 2 μs. A measurement pulse is captured in the case of the time of flight Δt_A,i of 1 μs. An averaging of a plurality of successive individual measurements as shown in FIG. 2a is effected in FIG. 2b. By way of example, in accordance with FIG. 2b, five individual measurements were used in order to improve a signal-to-noise ratio. An averaging is particularly advantageous if the noise margin or a signal-to-noise ratio is less than or equal to 2. By way of example, a maximum detection range of 300 m can be achieved with the capture time Δt_M of 2 μs. The individual measurement begins with the emission of the measurement pulse 10, see FIG. 1, and extends over the capture time Δt_M. The plurality of individual measurements in accordance with FIG. 2b are a measurement series, which, however, by definition can also consist of one individual measurement.

A signal evaluation on the basis of a histogram is shown in accordance with FIG. 3, wherein the ordinate shows the number c of individual measurements. Firstly the measurement pulse 10 captured from individual measurements in accordance with FIG. 2a and furthermore a captured interference pulse 16 are evident in this case. It is assumed in this example that the distance detection systems 4, 6 from FIG. 1 operate on the same time base. The special case is furthermore assumed that the interference pulse 16 is emitted at the instant at which the measurement pulse 14 is reflected at the vehicle 2. As a result, an illusory object arises at a distance d/2, wherein the distance d is depicted in FIG. 1. In the likely case that both time bases are shifted by a constant, the interference pulse 16 or the apparent echo would accordingly be provided at a different point on the time axis of the histogram in FIG. 3. In accordance with FIG. 3, all the measurement pulses recorded during a total measurement duration Δt_int are plotted in the histogram. If all the time of flight values Δt_A,i of a measurement series were identical, for example, then in FIG. 3 the result would be a single line of height n at t=Δt_A, wherein Δt_A is the time of flight. However, on account of measurement inaccuracies, a finite distribution width δ_A arises in the histogram in accordance with FIG. 3. The total measurement duration Δt_int is chosen such that a quasi-static situation can be assumed.

In contrast to FIG. 3, the time of flight values Δt_A,i of the measurement pulses 10, the distance of which temporally is varied stochastically, are now plotted in accordance with FIG. 4a. As a result, the time of flight values of the interference pulse 16 occur at different points in the histogram, as a result of which the time of flight Δt_A is easily able to be inferred from the histogram in FIG. 4a. In other words, interference signals that arise by way of multiple reflections, for example, can be masked out with the histogram in accordance with FIG. 4a on account of the stochastic variation of the pulse emission of the measurement pulses 10 and of the start of the measurement time. This is the case since the interference signals, on account of their random nature, in the histogram in accordance with FIG. 4a or the time histogram, form a background against which the recorded measurement pulses of direct reflections can be discriminated without any problems. Consequently, the regularly or irregularly arriving interference pulses 16 of the distance detection system 6, see FIG. 1, are distributed on the time axis of the histogram in FIG. 4a, such that they form a kind of background by means of which the actually relevant measurement pulses 10 can be discriminated without any problems. Preferably, a variation amplitude δ_t is large relative to the distribution width δ_A, see FIG. 3, of all the time of flight values Δt_A,i, wherein the variation amplitude δ_t is the change in the temporal distance between the individual measurement pulses. In FIG. 4a, the variation amplitude δ_t is Δt_M/2, for example, wherein Δt_M is the capture time of an individual measurement. Smaller or larger values can also be used. Preferably, uniformly distributed random numbers can be used for δ_t.

A threshold value normalized to the mean value of a histogram frequency C̅(̅t̅)̅ can be used as a criterion for discriminating the time of flight Δt_A from FIG. 4a. In this case, the threshold value can be changed in such a way that only histogram values with C(t_i)/C(t) approximately greater than or equal to 2 are used for the peak recognition and thus the time of flight measurement. Afterward a maximum value of the histogram value could be used for the temporal peak position.

Consequently, in accordance with FIG. 4a, the sequence of the measurement pulses can be varied stochastically, which makes it possible to filter out an interference pulse in one individual measurement or in a plurality of individual measurements or in the evaluation of the histogram. The following method in accordance with FIG. 4b can preferably be provided in this case. In a first step 18, an individual measurement in accordance with FIG. 2a or a measurement series in accordance with FIG. 2b can be carried out in this case. The subsequent step 20 involves extracting the time of flight value Δt_A,i from the individual measurement in accordance with FIG. 2a or the measurement series in accordance with FIG. 2b. The time of flight value Δt_A,i determined or the time of flight values Δt_A,i determined is/are then plotted in the histogram in accordance with FIG. 4a, which is provided in a subsequent step 22. Afterward, in a step 24, an individual measurement or a measurement series can be repeated as necessary until a sufficient quality of the histogram in accordance with FIG. 4a is reached. If a plurality of individual measurements are carried out or a measurement series with a plurality of individual measurements is carried out, then a stochastic variation of the sequence of the individual measurements is preferably effected in this case. A subsequent step 26 then involves determining the time of flight Δt_A from the maximum value of the histogram in accordance with FIG. 4a. It is conceivable to dispense with the generation of the histogram, in principle, since this depends in detail on the respective application requirements in respect of accuracy and interference immunity. This is particularly advantageous, however, against the background of the approach of stochastic variation.

As an alternative or in addition to the variation of the temporal distance, the configuration of the emitted measurement pulses 10, see FIG. 1, can also be varied or be varied stochastically. In accordance with FIG. 5a, a reference measurement pulse 28 is shown, for example, which is based on an emitted measurement pulse 10, see FIG. 1. It is evident that a falling edge 30 of the reference measurement pulse 28 is comparatively long from a temporal standpoint. If a measurement pulse 10, see FIG. 1, of the distance detection system 4 is emitted, then a reference measurement pulse such as is shown in FIG. 5a is recorded for a respective measurement pulse 10, particularly if the latter is varied or is varied stochastically. In other words, with the reference measurement pulse 28 an internal reference path is realized by the pulse shape emitted in an individual measurement being recorded. The reference measurement pulse is then compared with the measurement pulse captured by means of the distance detection system 4, in particular during the capture time Δt_M, in order to ascertain whether the captured measurement pulse is the emitted measurement pulse 10 or some other pulse, such as an interference pulse, for example. In accordance with FIG. 5a, a measurement pulse 32 received by the distance detection system 4 from FIG. 1 is illustrated besides the reference measurement pulse 28. An interference pulse 34 is formed in the falling edge 30 of said measurement pulse 32. The measurement pulse 32 arrives at t=100 ns and is superimposed by the interference pulse 34 of comparable amplitude at t of approximately 140 ns.

In accordance with FIG. 5b, the measurement pulse 32 is then compared with the reference measurement pulse 28 by means of a comparison method in the form of a cross-correlation function, see FIG. 5a. Consequently, in accordance with FIG. 5b, in order to differentiate the intrinsic signal from interference or extraneous signals, the cross-correlation function X_SR between the internal reference measurement pulse 28 and the measurement pulse 32 captured by means of the distance detection system 4 is calculated, the result X_SR of the cross-correlation function being represented by X on the ordinate in FIG. 5b. On account of a discrete sampling of the measurement pulse 32, the discrete definition of the cross-correlation function is accordingly used:

X_{SR}=Σₜ₌₀ⁿR(n)*S(n+τ)

wherein n is the number of measurement pulses recorded over the capture time Δt_M, and T is the displacement parameter from which the time of flight Δt_A can be determined proceeding from the maximum of the function In accordance with FIG. 5b, it can be ascertained that a maximum of the cross-correlation function is at the time of flight Δt_A of 100 ns since the time of flight Δt_A of 100 ns can be read from the clearly discernible maximum at T=100 ns. Consequently, despite the occurrence of the interference pulse 34 from FIG. 5a, the correct time of flight Δt_A of the measurement pulse 32 is determined on the basis of the cross-correlation function. It is conceivable to carry out a comparison method after a respective individual measurement or after a measurement series. The time of flight values Δt_A determined can furthermore be processed further by means of the histogram method.

The comparatively long falling edge 30 of the measurement pulse 32 is evident in accordance with FIG. 5a. The configuration and/or the gradient and/or the length of the falling edge can advantageously be varied or be varied stochastically, in particular in a predetermined range. Alternatively or additionally, it is conceivable for the gradient and/or configuration and/or length of the rising edge of the measurement pulse 32 to be varied or to be varied stochastically, in particular within predetermined limits. It is also conceivable, alternatively or additionally, for the pulse width of the measurement pulse 32 to be varied or to be varied stochastically, in particular within predefined limits. Moreover, the entire pulse shape can be varied or be varied stochastically, in particular within predefined limits, for example in a Gaussian shape or Lorentzian shape or sawtooth shape. A pulse width can be varied extremely simply, wherein it is conceivable for the gradients of the rising and/or falling edges also to be influenced. The configuration of the measurement pulse is preferably effected by corresponding driving of the emitter unit 8, see FIG. 1, which can be at least one laser diode, wherein the driving can be realized by means of the electronic driver of the laser diode.

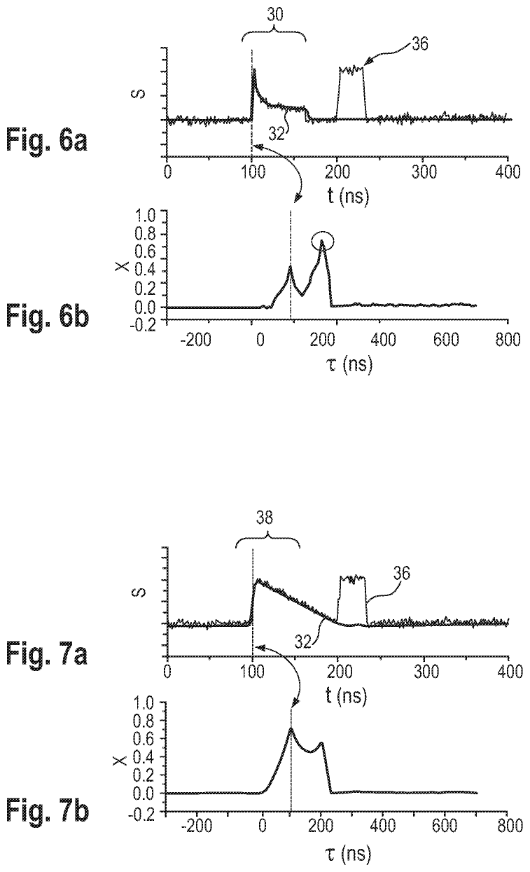

In accordance with FIG. 6a, a situation is shown in which, besides the measurement pulse 32, a comparatively wide interference pulse 36 is captured by the distance detection system 4 from FIG. 1. In accordance with FIG. 6a, therefore, the measurement pulse 32 arrives at approximately 100 ns and the interference pulse 36 arrives at approximately 200 ns. This has the consequence that in the cross-correlation function in accordance with FIG. 6b a maximum is determined at T=200 ns. By contrast, the measurement pulse 32 in accordance with FIG. 6a arrives at 100 ns. In order that the correct time of flight Δt_A is able to be determined by means of the cross-correlation function despite the comparatively wide interference pulse 36, in accordance with FIG. 7a, a falling edge 38 of the measurement pulse 32 can then be widened, as a result of which the measurement pulse 32 is significantly longer. The area or the integral of the measurement pulse 32 is then greater than that of the interference pulse 36. By this means, the interference pulse 36 is practically masked and the correct time of flight Δt_A at 100 ns is captured as a result of the cross-correlation function in FIG. 7b. It is thus also conceivable to increase the limits or the range in which the falling edge 38 is varied or is varied stochastically. Alternatively or additionally, the cross-correlation function in accordance with FIG. 6b or 7b can be followed by the histogram method, in which the captured times of flight Δt_A are entered, and it is thus also possible for example to discriminate the times of flight of the interference pulses 36 in accordance with FIG. 6a despite a comparatively short falling edge 30.

In FIG. 8a, the distance detection system 4 from figure has emitted a plurality of measurement pulses 40 to 44 successively with an identical width, the received measurement pulses 40 to 44 being shown in accordance with FIG. 8a. In this case, a temporal distance between the respective measurement pulses 40, 42 and 44 is variable or stochastically variable, in particular in a predetermined range. Consequently, in the capture time Δt_M a plurality of measurement pulses are emitted, the temporal distances or times of flight Δt_i of which are varied stochastically with respect to one another, whereby a modulation of the pulse sequence is effected. In accordance with FIG. 8a, besides the three measurement pulses 40, 42 and 44, in addition an interference pulse 46 is concomitantly captured. If the comparison method in the form of the cross-correlation function is then carried out in accordance with FIG. 8b, then a clearly discernible maximum at T=100 ns results, whereby the time of flight Δt_A of 100 ns is able to be determined. Afterward, the histogram method can additionally be carried out after this individual measurement or after a plurality of individual measurements or after a measurement series. Consequently, a dominant test signal can be discriminated by means of the stochastic variation of the temporal distances within the individual measurement in conjunction with the histogram method by means of the histogram on the basis of a sufficient number of measurements. For the histogram method, for a respective individual measurement, for example, the position of the maximum of the cross-correlation function in accordance with FIG. 8b can be used or the positions of n-highest discernible maxima are used, wherein n is definable. Depending on the type of interference pulse that occurs, one variant or the other may be more robust, wherein the selection may then depend on the exact application requirements.

In accordance with FIG. 8a, it is also conceivable, besides the temporal distances, for the number of individual measurement pulses also to be varied or to be varied stochastically, in particular within predefined limits. This can enable for example advantages for complying with thermal limits of the distance detection system 4, in particular of the emitter unit 8.

It is also conceivable, besides the temporal distances and/or the number of measurement pulses, for one or more further parameters to be varied or to be varied stochastically, in particular within specific limits. In this regard, by way of example, the shape of a respective measurement pulse can also be varied.

In the text above, for the comparison method, the cross-correlation function was used for measuring a similarity between a reference pulse and a measurement pulse, in order thus to realize interference suppression. It is conceivable, alternatively or additionally, to use one or more other methods which can yield a quantified value for a similarity of two signals.

As an alternative or in addition to the comparison method, in particular with the cross-correlation function, it is conceivable to discriminate interference pulses by means of an adaptation of an analytical function. In this case, characteristic shape parameters of the measurement pulse can be extracted and be compared with parameters generated in the reference measurement pulse or reference path. By way of example, the full width at half maximum of the falling edge 30 in FIG. 5a could be used as a shape parameter. Only measurement pulses which have the correct or same full width at half maximum would then be used with regard to ascertaining the time of flight Δt_A. This method would be robust in particular vis à vis interference pulses having a significantly larger amplitude than the intrinsic measurement signal. The method can comprise the following steps for example in accordance with FIG. 8c:
A step 48 involves identifying possible temporal pulse positions of measurement pulses, for example proceeding from the position of maximum values.
A further step 50 can involve adapting an analytical function and/or ascertaining the relevant shape parameters.
In the further step 52, the relevant shape parameters or the relevant shape parameter can be compared with the shape parameter or the shape parameters of the reference measurement pulse.
The next step 54 involves ascertaining the time of flight value Δt_A,i for the measurement pulse which has the best correspondence with regard to the shape parameters or the shape parameter.
In the further step 56, an individual measurement or measurement series can optionally be repeated. Furthermore, optionally after the individual measurement or the individual measurements or the measurement series, the histogram method can be used for ascertaining the time of flight Δt_A.

In a further embodiment in accordance with FIG. 9a, in an individual measurement, three measurement pulses 58, 60 and 62 are emitted one after another, the distances between which vary randomly. The received measurement pulses 58, 60 and 62 received by the distance detection system 4, see FIG. 1, are illustrated in accordance with FIG. 9b. Furthermore, a respective reference measurement pulse 64, 66 and 68 is provided for the respective measurement pulse 58 to 62 in FIG. 9b. Afterward, the cross-correlation function is calculated from the measurement pulses 58 to 62 and the reference measurement pulses 64 to 68, the result being illustrated in FIG. 9c. A maximum of the cross-correlation function is provided at t=300 ns, which corresponds to the time of flight Δt_A of the measurement pulses 58 to 62. The amplitude is less than 1 here on account of the noise component.

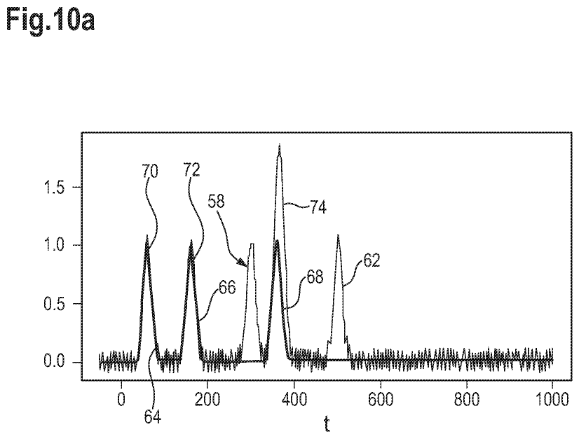

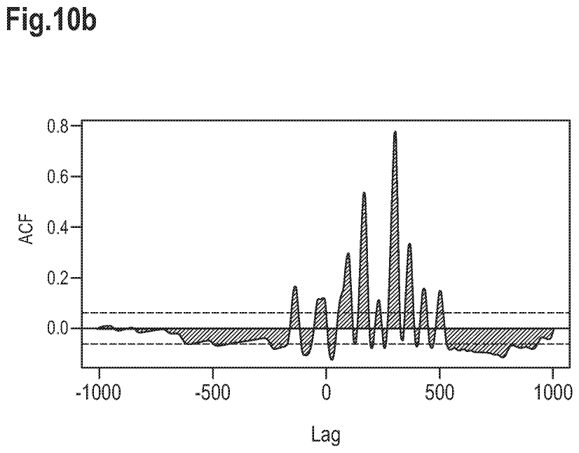

In FIG. 10a, in contrast to FIG. 9b, interference pulses 70, 72 and 74 are additionally received. In this case, the interference pulse 74 is superposed on the measurement pulse 60 from FIG. 9b. Furthermore, the measurement pulses 58 and 62 are discernible. Moreover, the reference measurement pulses 64, 66 and 68 are evident in FIG. 10a. With the cross-correlation function, the reference measurement pulses 64, 66 and 68 are compared with the received measurement pulses for which the interference pulses 70, 72 and 74 are also provided, the result being evident in FIG. 10b. It can be discerned that in accordance with FIG. 10b the maximum of the cross-correlation function is still at the correct time of flight Δt_A of 300 ns despite the interference pulses.

In accordance with FIG. 11a, the distance detection system 4, see FIG. 1, receives three measurement pulses 76, 78 and 80 emitted thereby together with an interference pulse 82. In accordance with FIG. 11a, by means of the cross-correlation function, the reference measurement pulses—not shown in FIG. 11a—are then compared with the received signals. In this case, the cross-correlation function in accordance with FIG. 11b no longer yields the correct time of flight. Advantageously, a histogram evaluation can additionally be performed. By way of example, the histogram in accordance with FIG. 11c is based on 100 individual measurements. The correct time of flight Δt_M of 500 ns can then be gathered from the histogram. In the histogram in accordance with FIG. 11c, in a respective individual measurement, use is made of the position of the respective fifth-highest peaks in the associated cross-correlation function. In the histogram in accordance with FIG. 11d, by contrast, only the respective peak of the cross-correlation function is used in a respective individual measurement. Here, too, it is possible to determine the correct time of flight Δt_M at 500 ns.

The invention provides a distance detection system by which electromagnetic measurement pulses are able to be emitted and received. A configuration and/or a sequence and/or a number of the emitted measurement pulses, in particular during a total measurement duration, are/is varied in this case.

### LIST OF REFERENCE SIGNS

| | |
|---|---|
| Vehicle | 1, 2 |
| Distance detection system | 4, 6 |
| Emitter unit | 8 |
| Measurement pulses | 10, 14, 16; 32; |
| | 40, 42, 44; 58, |
| | 60, 62; 76, 78, |
| | 80 |
| Receiver unit | 12 |
| Recording device | 17 |
| Control unit | 19 |
| Step | 18, 20, 22, 24, |
| | 26; 48, 50, 52, |
| | 54, 56 |
| Reference measurement pulse | 28; 64, 66, 68 |
| Falling edge | 30; 38 |
| Interference pulse | 34; 36; 46; 70, |
| | 72, 74; 82 |
| Number | c |
| Signal strength | s |
| Time | t |
| Displacement parameter | τ |
| Cross-correlation function | X |

1. A distance detection system comprising:
an emitter unit configured to emit electromagnetic measurement pulses for distance measurements; and
a receiver unit configured to capture the electromagnetic measurement pulses, characterized in that at least one of a shape, a temporal distance, and a number of the emitted measurement pulses are varied.

2. The distance detection system as claimed in claim 1, wherein the variation provided is a variation of at least one of a gradient, a shape, and a width of a falling and/or rising edge of an emitted measurement pulse.

3. The distance detection system as claimed in claim 1, wherein the variation is limited.

4. The distance detection system as claimed in claim 1, further comprising a recording device for recording a reference measurement pulse of the respective measurement pulse emitted by the emitter unit.

5. The distance detection system as claimed in claim 4, further comprising a control unit configured to compare the reference measurement pulse recorded by the recording device with a measurement pulse received by the receiver unit.

6. The distance detection system as claimed in claim 5, wherein the control unit is configured in such a way that the comparison of the measurement pulses is effected by means of a comparison method configured to compare two pulse shapes.

7. The distance detection system as claimed in claim 1, wherein the variation is effected stochastically.

8. A method with a distance detection system as claimed in claim 1, wherein at least one of a shape, a sequence, and a number of the emitted electromagnetic measurement pulses are varied.

9. The method as claimed in claim 8 comprising the following step:
carrying out a measurement series with at least one individual measurement or a plurality of individual measurements, wherein an individual measurement begins with the emission of a measurement pulse and extends over a capture time of the receiver unit.

10. The method as claimed in claim 8, comprising the following step:
determining a time of flight value of a measurement pulse or of a respective measurement pulse, wherein determining the time of flight value of a measurement pulse or of a respective measurement pulse is effected by means of at least one of a comparison method, a cross-correlation method, and a histogram method.

11. The method as claimed in claim 10, wherein the histogram method is used on the basis of the result of the comparison method.

12. The method as claimed in claim 9, wherein a temporal position of the maxima of the time of flight or the temporal positions of the n-highest maxima of the time of flight are determined after each individual measurement or after each measurement series.

13. A vehicle comprising a distance detection system as claimed in claim 1.

14. (canceled)
